(19) United States
(12) Patent Application Publication
(10) Pub. No.: US 2013/0181638 A1
(43) Pub. Date: Jul. 18, 2013

(54) MEDICAL IMAGE DIAGNOSIS APPARATUS AND TOP-BOARD MOVING UNIT

(71) Applicant: Hidefumi Komatsu, Nasushiobara-shi (JP)

(72) Inventor: Hidefumi Komatsu, Nasushiobara-shi (JP)

(73) Assignees: TOSHIBA MEDICAL SYSTEMS CORPORATION, OTAWARA-SHI, TOCHIGI-KEN (JP); KABUSHIKI KAISHA TOSHIBA, TOKYO (JP)

(21) Appl. No.: 13/382,844

(22) PCT Filed: Aug. 11, 2011
(86) PCT No.: PCT/JP2011/004550

§ 371 Date: Jan. 6, 2012

(30) Foreign Application Priority Data
Aug. 19, 2010 (JP) 2010-184447

(51) Int. Cl. H02K 57/00

(52) U.S. Cl. CPC H02K 57/006
USPC 318/3

(57) ABSTRACT

According to one embodiment, a top-board moving unit includes a top-board moving motor, a drive-signal generating means and a charge-discharge means. The top-board moving motor moves, in a prescribed direction, a top board on which a subject is placed. The drive-signal generating means generates drive signals for operating the top-board moving motor. The charge-discharge means charges and discharges regenerative electric power generated in the top-board moving motor.

### CROSS-REFERENCE TO RELATED APPLICATION

This application is based upon and claims the benefit of priority from Japanese Patent Application No. 2010-184447, filed on Aug. 19, 2010 and is National Stage entry from PCT International Application No. PCT/JP2011/004550; the entire contents of which are incorporated herein by reference.

### FIELD OF THE INVENTION

Embodiments of the present invention are related to a medical image diagnosis apparatus and a top-board moving unit that are able to effectively use regenerative electric power generated during the deceleration of a top-board moving motor.

### BACKGROUND OF THE INVENTION

Medical image diagnosis has undergone rapid advancements due to X-ray CT devices and MRI devices, etc. that have been realized in practical use through the development of computer technology, and has become essential in modern medicine. In particular, X-ray CT devices and MRI devices, etc. of recent years allow for image data of multiple slice cross-sections to be acquired and displayed easily due to enhancement in the speed and performance of detection units and arithmetic processing units for biological information.

For example, in an X-ray CT device, by rotating an X-ray tube and an X-ray detector arranged to surround and face a patient or subject to be examined (hereinafter referred to as “subject”) at high speeds while continuously moving the subject in the body axial direction, projection data of multiple slice cross-sections are acquired, and by performing a reconstruction process on these projection data, image data and three-dimensional data (volume data) of these slice cross-sections are generated. Moreover, in recent years, through the application of multi-slice systems using an X-ray detector in which detection elements are arranged in a two-dimensional array, the time required to acquire projection data of a three-dimensional region has been further reduced.

At the same time, technical developments in a medical image diagnosis apparatus has been accompanied by increases in heat generation within the devices, acting as a significant factor in the deterioration of device performance and function, and countermeasures are therefore important. In particular, in medical image devices that have a top-board moving unit for moving a top board on which a subject is placed, such as X-ray CT devices, X-ray diagnostic devices, or even MRI devices, heat generation caused by the regenerative electric power of the top-board moving motor provided in the movement mechanism has been a problem. In other words, as a result of regenerative electric power generated during the deceleration of the top-board moving motor, heat is generated in the top-board moving motor as well as the movement mechanisms provided nearby, and this heat generation has made the continuous movement operations of the top board difficult. Therefore, a conventional medical image diagnosis apparatus has used a method in which a regenerative resistor that expends the regenerative electric power is connected to the top-board moving motor, and by using the regenerative electric power fed from the top-board moving motor, the heat generated in the regenerative resistor is diffused externally via a heat-releasing mechanism such as a chassis or a fan, etc.

### BRIEF DESCRIPTION OF THE DRAWINGS

FIG. 1 is a block diagram showing the overall configuration of the medical image diagnosis apparatus according to the present embodiment.

FIG. 2 is a block diagram showing the specific configuration of a top-board moving unit included in the medical image diagnosis apparatus according to the present embodiment.

FIG. 3 is a diagram showing the circuit configurations of an AC/DC conversion part and a DC/AC conversion part included in the top-board moving unit according to the present embodiment.

FIG. 4 is a diagram showing the specific configurations of a switching part and a step-up/step-down part included in the top-board moving unit according to the present embodiment.

FIG. 5 is a diagram for explaining the generation timing of regenerative electric power in the present embodiment.

FIG. 6 is a diagram showing the specific configuration of a top-board moving unit according to a first modification of the present embodiment.

FIG. 7 is a diagram showing the specific configuration of a top-board moving unit according to a second modification of the present embodiment.

### DETAILED DESCRIPTION

According to one embodiment, a top-board moving unit includes a top-board moving motor, a drive-signal generating means and a charge-discharge means. The top-board moving motor moves, in a prescribed direction, a top board on which a subject is placed. The drive-signal generating means generates drive signals for operating the top-board moving motor. The charge-discharge means charges and discharges regenerative electric power generated in the top-board moving motor.

Moreover, according to one embodiment, a medical image diagnosis apparatus performs various types of imaging by moving, in a prescribed direction, a top board on which a subject is placed, and moves the top board by using a top-board moving unit. The top-board moving unit includes a top-board moving motor, a drive-signal generating means and a charge-discharge means. The top-board moving motor moves, in the prescribed direction, a top board on which a subject is placed. The drive-signal generating means generates drive signals for operating the top-board moving motor. The charge-discharge means charges and discharges regenerative electric power generated in the top-board moving motor.

The following is a description of the embodiment of the present disclosure, with reference to the drawings.

A top-board moving unit included in a medical image diagnosis apparatus according to the present embodiment includes: a top-board moving motor that moves a top board in a desired direction; and a charge-discharge part that stores regenerative electric power generated in the top-board moving motor, and when moving the top board on which a subject is placed using the top-board moving motor, regenerative electric power generated during the deceleration of the top-board moving motor is stored in a secondary battery of the charge-discharge part. Then, the obtained regenerative electric power is used for the driving power required for rotating the top-board moving motor, or for standby power required for operating the top-board moving unit, etc.

Although the following description is of a medical image diagnosis apparatus that allows for the generation of X-ray CT image data, embodiments are not limited to this, and may be a medical image diagnosis apparatus that generates, for example, X-ray image data, MRI image data, or nuclear medical image data, etc.

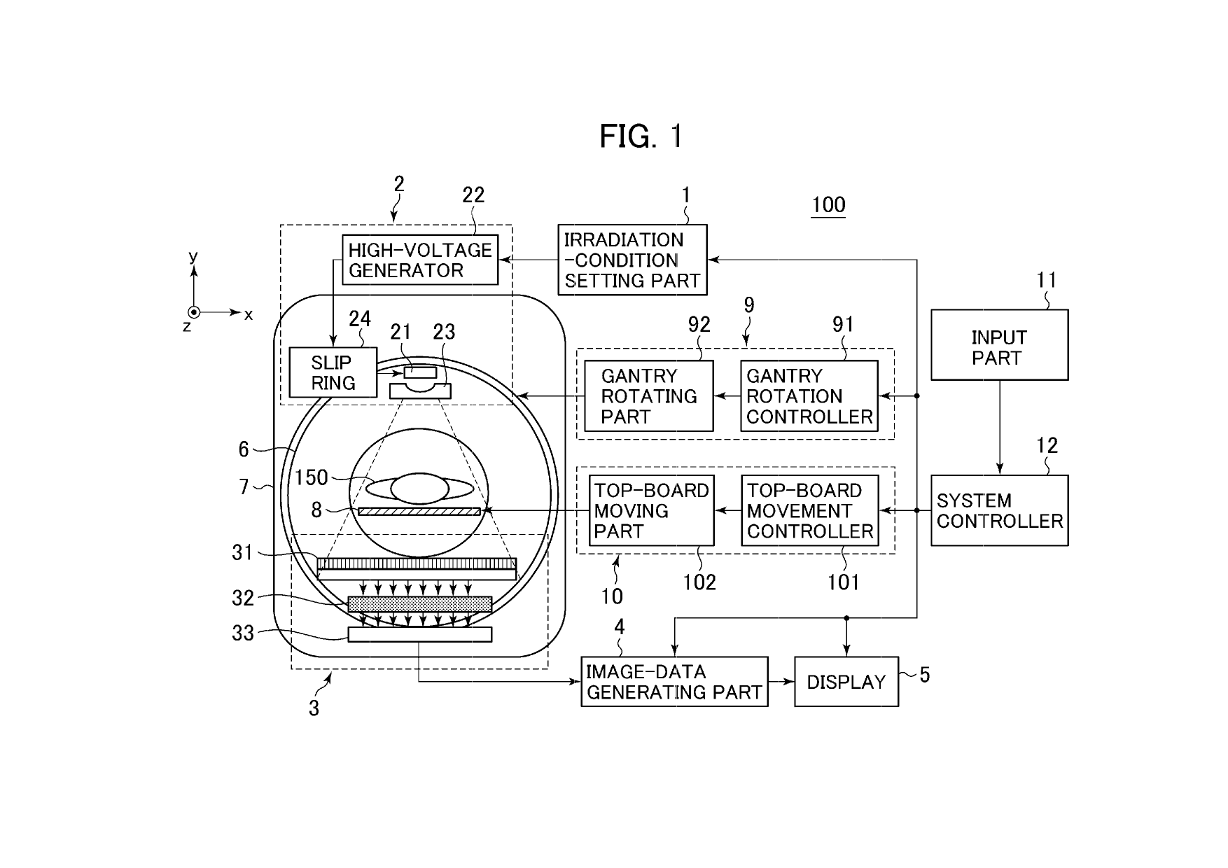

The configuration and functions of the medical image diagnosis apparatus according to the embodiment of the present disclosure are described with reference to FIG. 1 through FIG. 5. FIG. 1 is a block diagram showing the overall configuration of the medical image diagnosis apparatus.

The medical image diagnosis apparatus 100 shown in FIG. 1 includes an Irradiation-condition setting part 1, an X-ray generating part 2, a projection-data generating part 3, an image-data generating part 4, and a display 5. The Irradiation-condition setting part 1 generates irradiation control signals based on X-ray irradiation conditions of imaging conditions fed from an input part 11 described below. The X-ray generating part 2 irradiates a subject 150 with X-rays in accordance with the irradiation control signals fed from the Irradiation-condition setting part 1. The projection-data generating part 3 detects X-rays that have passed through the subject 150 and generates projection data. The image-data generating part 4 performs a reconstruction process on projection data generated by the projection-data generating part 3 and generates image data (X-ray CT image data). The display 5 displays image data generated by the image-data generating part 4.

Moreover, the medical image diagnosis apparatus 100 includes a rotating gantry part 6, a fixed gantry part 7, a top board 8, a gantry rotating unit 9, a top-board moving unit 10, the input part 11, and a system controller 12. The rotating gantry part 6 is mounted with part of the X-ray generating part 2 and the projection-data generating part 3, and performs high-speed rotation at a prescribed velocity around the subject 150. The fixed gantry part 7 holds the rotating gantry part 6. The top board 8 is attached to the top surface of a bed (not shown), on which the subject 150 is placed, and moves an area undergoing examination to an imaging field provided in the center of the rotating gantry part 6. The gantry rotating unit 9 causes the rotating gantry part 6 to undergo high-speed rotation in a prescribed direction. The top-board moving unit 10 moves the top board 8 on which the subject 150 is placed in a prescribed direction. The input part 11 performs the setting of imaging conditions, the setting of image-data generation conditions and image-data display conditions, and the input of various instruction signals, including movement instruction signals for starting and ending movement of the top board 8. The system controller 12 performs overall control of each abovementioned unit provided in the medical image diagnosis apparatus 100.

Next, the configurations and functions of each abovementioned unit included in the medical image diagnosis apparatus 100 are described in further detail.

The Irradiation-condition setting part 1 shown in FIG. 1 generates irradiation control signals based on X-ray irradiation conditions (e.g., tube voltage, tube current, and X-ray irradiation time) of imaging conditions fed from the input part 11 via the system controller 12, and feeds the irradiation control signals to the X-ray generating part 2.

The X-ray generating part 2 includes: an X-ray tube 21 that irradiates the subject 150 with X-rays; a high-voltage generator 22 that generates a high voltage applied between the anode and cathode of the X-ray tube 21; an X-ray diaphragm device 23 that controls the irradiation range on the subject 150 of X-rays emitted from the X-ray tube 21; and a slip ring 24 that feeds the abovementioned high voltage generated by the high-voltage generator 22 to the X-ray tube 21 provided on the rotating gantry part 6.

The X-ray tube 21 is a vacuum tube that generates X-rays, and irradiates X-rays by causing electrons accelerated by the high voltage fed from the high-voltage generator 22 to collide with a tungsten target. On the other hand, the X-ray diaphragm device 23 is provided between the X-ray tube 21 and the subject 150, and has a function to refine X-rays irradiated from the X-ray tube 21 to a prescribed imaging region, as well as a function to set the irradiation intensity distribution of X-rays on the subject 150. For example, it forms X-ray beams irradiated from the X-ray tube 21 into X-ray beams of a cone-beam shape or a fan-beam shape.

Next, the projection-data generating part 3 includes: an X-ray detector 31 that detects X-rays that have passed through the subject 150; a data acquisition unit (hereinafter referred to as “DAS (Data Acquisition System) unit”) 32 that performs current/voltage conversion and A/D conversion on multi-channel detection signals (projection data) output from the X-ray detector 31; and a data transmission circuit 33 that performs parallel/serial conversion, electricity/light/electricity conversion, and serial/parallel conversion on output signals of the DAS unit 32.

The X-ray detector 31 of the projection-data generating part 3 includes, for example, multiple X-ray detection elements (not shown) arranged in a two-dimensional array, and each of these X-ray detection elements is configured by a scintillator that converts X-rays into light and a photodiode that converts light into electrical signals. Furthermore, these X-ray detection elements are attached to the rotating gantry part 6 in a circular arc with the focal point of the X-ray tube 21 at the center.

On the other hand, the DAS unit 32 performs current/voltage conversion and A/D conversion on projection data fed from the X-ray detector 31. Furthermore, the data transmission circuit 33 includes a parallel/serial converter, an electricity/light/electricity converter, and a serial/parallel converter that are not shown, and projection data output from the DAS unit 32 are converted into chronological single-channel projection data in the parallel/serial converted attached to the rotating gantry part 6, and are fed to the serial/parallel converted attached to the fixed gantry part 7 via optical communication using the electricity/light/electricity converter.

Next, in the serial/parallel converter, the single-channel projection data are returned to the multi-channel projection data and stored in a projection-data memory of the image-data generating part 4. Furthermore, this data transmission method may be replaced by another method as long as signal transmission between the projection-data generating part 3 provided in the rotating gantry part 3 and the image-data generating part 4 provided on the outside of the fixed gantry part 7 is possible, and a device such as the slip ring described above, for example, may be used.

Furthermore, the X-ray tube 21 and X-ray diaphragm device 23 of the X-ray generating part 2 and the abovementioned projection-data generating part 3 are loaded onto the rotating gantry part 6 facing each other across the subject 150, and undergo high-speed rotation about an axis parallel to the body-axis direction (z-axis direction) of the subject 150 due to the movement mechanism part 10.

Next, the image-data generating part 4 includes a projection data memory and a reconstruction processing part that are not shown, and has a function to generate image data by performing a reconstruction process on projection data acquired through X-ray CT imaging using the X-ray generating part 2 and the projection-data generating part 3.

In other words, in the projection data memory, projection data from, for example, multi-slice mode that have been acquired through high-speed rotation of the rotating gantry part 6 around the subject 150 are stored with the rotation-angle information of the rotating gantry part 6 as supplementary information.

On the other hand, the reconstruction processing part includes a program storage part that preliminarily stores various processing programs, and a calculator. The calculator receives image-data generation conditions fed from the input part 11 via the system controller 12, and reads out a processing program suitable for the reconstruction process meeting the image-data generation conditions from the program storage part. Then, by performing the reconstruction process on the projection data read out from the abovementioned projection data memory using the processing program, image data for multiple slice cross-sections are generated.

The display 5 includes a display-data generating part and a monitor that are not shown. The display-data generating part converts image data generated by the image-data generating part 4 into a prescribed display format to generate display data, and displays the data on the monitor.

Next, the gantry rotating unit 9 has a function for causing the rotating gantry part 6, to which the X-ray tube 21 of the X-ray generating part 2 and the X-ray detector 31 of the projection-data generating part 3 are loaded facing each other, to undergo high-speed rotation around the subject 150, and as shown in FIG. 1, it includes a gantry rotation controller 91 and a gantry rotating part 92.

Based on imaging conditions for X-ray CT imaging and imaging-initiation instruction signals fed from the input part 11 via the system controller 12, the gantry rotation controller 91 generates rotation control signals that determine the rotational velocity and rotation angle, etc. On the other hand, the gantry rotating part 92 includes: a motor for gantry rotation (not shown) that causes the rotating gantry part 6 to undergo high-speed rotation at a prescribed velocity; and a drive-signals generating part (not shown) that generates drive signals for the motor for gantry rotation.

On the other hand, the top-board moving unit 10 has functions for arranging the area undergoing examination of the subject 150 undergoing X-ray CT imaging in the imaging field of the rotating gantry part 6, as well as for moving the subject 150 to a prescribed removal position after X-ray CT imaging is completed, by moving the top board 8 on which the subject 150 is placed in parallel to a prescribed direction.

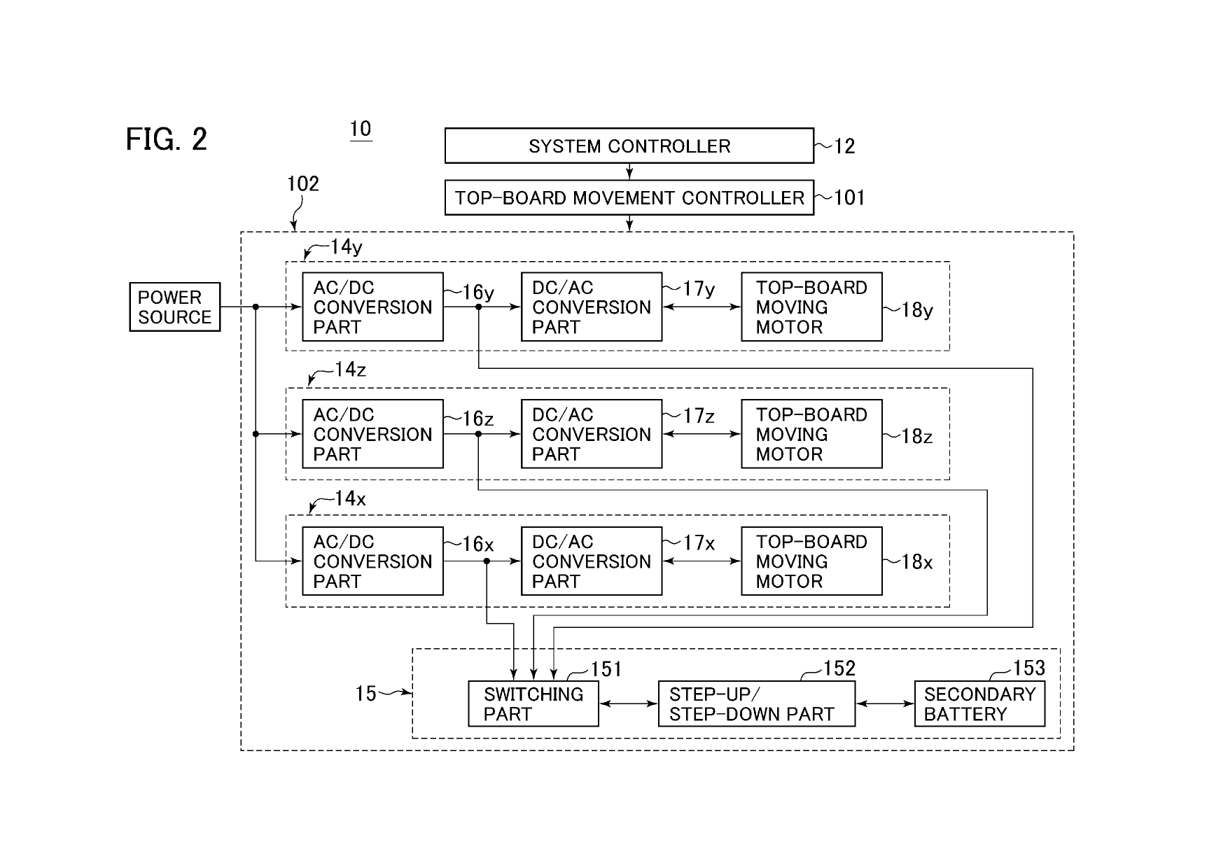

Next, the specific configuration of the top-board moving unit 10 is described with reference to the block diagram of FIG. 2. This top-board moving unit 10 includes a top-board movement controller 101 and a top-board moving part 102. The top-board movement controller 101 generates movement control signals based on movement-initiation instruction signals for initiating movement of the top board 8 or on movement-stopping instruction signals for stopping movement of the top board 8 that are fed from the input part 11 via the system controller 12.

On the other hand, the top-board moving part 102 includes a vertical movement part 14y, an axial-direction movement part 14z, a longitudinal-direction movement part 14x, and a charge-discharge part 15. The vertical movement part 14y moves the top board 8 on which the subject 150 is placed in the vertical direction (y-direction in FIG. 1). The axial-direction movement part 14z moves the top board 8 in the direction of the body axis of the subject 150 (z-direction in FIG. 1). The longitudinal-direction movement part 14x moves the top board 8 in a longitudinal direction (x-direction in FIG. 1) of the subject 150 that is perpendicular to the vertical direction and the axial direction. The charge-discharge part 15 charges and discharges regenerative electric power generated in the vertical movement part 14y, the axial-direction movement part 14z, and the longitudinal-direction movement part 14x.

The vertical movement part 14y generates three-phase drive signals with a prescribed frequency and amplitude based on three-phase AC voltage fed from a normal power source, and has a function to move the top board 8 up and down in the y-direction based on these three-phase drive signals. For example, the vertical movement part 14y includes: an AC/DC conversion part 16y that rectifies three-phase AC voltage to convert it into DC voltage; a DC/DC conversion part (not shown) that converts the DC voltage into a prescribed DC voltage; a DC/AC conversion part (drive-signals generating part) 17y that converts the converted DC voltage into three-phase drive signals that have a prescribed frequency; and a top-board moving motor 18y that moves the top board 8 up and down in the y-direction based on the three-phase drive signals.

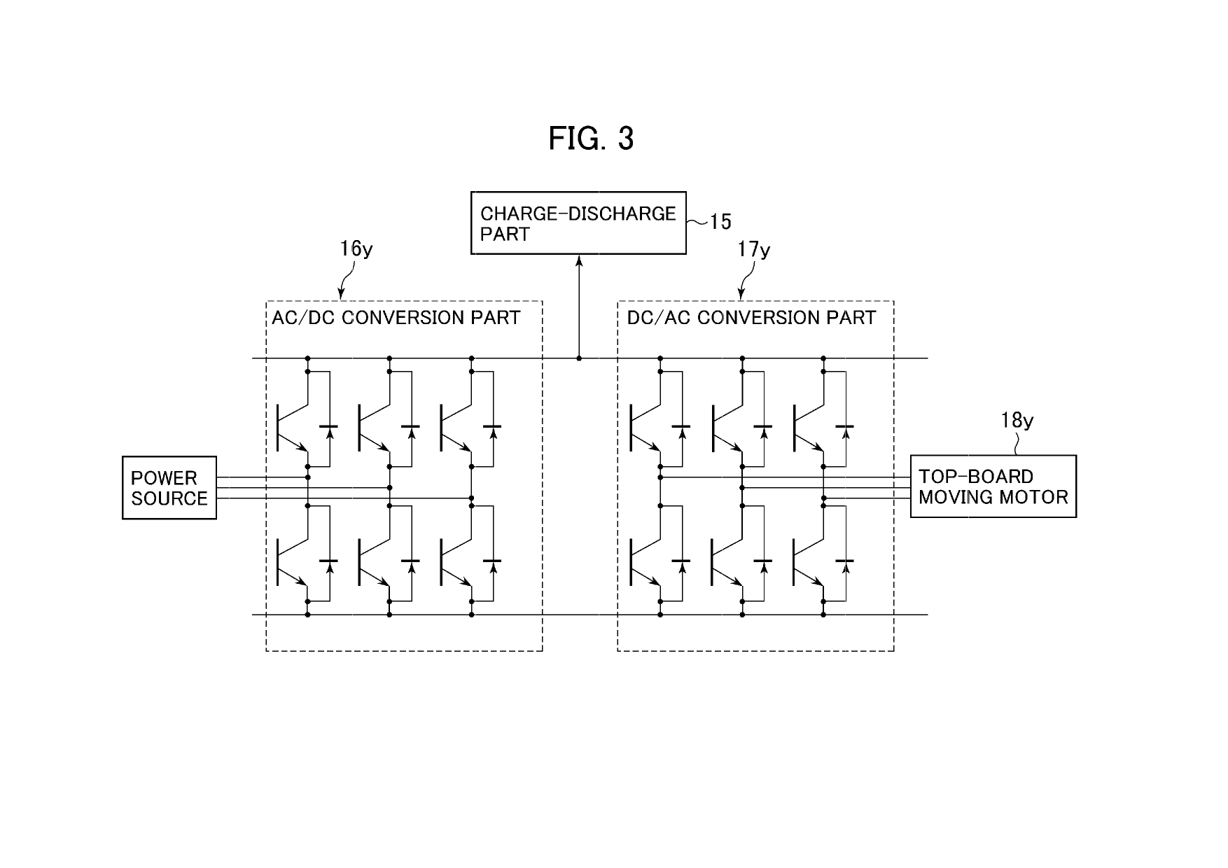

Here, the specific circuit configurations of the abovementioned AC/DC conversion part 16y and DC/AC conversion part 17y are shown in FIG. 3. This AC/DC conversion part 16y rectifies the three-phase AC voltage fed from a power source to convert it into DC voltage. On the other hand, the DC/AC conversion part 17y activates a high-voltage switching element such as, for example, an IGBT (Insulated-gate bipolar transistor) to convert DC voltage fed from the AC/DC conversion part 16y via the DC/DC conversion part (not shown) into three-phase AC voltage (three-phase drive voltage) having a prescribed frequency, and feeds it to the top-board moving motor 18y. Moreover, if the voltage of the regenerative electric power generated during the deceleration of the top-board moving motor 18y reaches a prescribed value, the DC/AC conversion part 17y feeds the regenerative electric power fed from the top-board moving motor 18y to the charge-discharge part 15 via the abovementioned switching element.

Similarly, the axial-direction movement part 14z provided in the top-board moving part 102 includes an AC/DC conversion part 16z, a DC/DC conversion part (not shown), a DC/AC conversion part 17z, and a top-board moving motor 18z, and the longitudinal-direction movement part 14x includes an AC/DC conversion part 16x, a DC/DC conversion part (not shown), a DC/AC conversion part 17x, and a top-board moving motor 18x. Then, the top-board moving motor 18z moves the top board 8 in the body-axis direction (z-direction) based on three-phase drive signals generated by the DC/AC conversion part 17z, and the top-board moving motor 18x moves the top board 8 in the longitudinal direction of the subject 150 (x-direction) based on three-phase drive signals generated by the DC/AC conversion part 17x. Moreover, the regenerative electric power generated during the deceleration of the top-board moving motor 18z and the top-board moving motor 18x is fed to the charge-discharge part 15 via the DC/AC conversion part 17z and the DC/AC conversion part 17x, respectively.

Next, the charge-discharge part 15 provided in the top-board moving part 102 of FIG. 2 has functions for charging and discharging regenerative electric power generated in the top-board moving motor 18y of the vertical movement part 14y, the top-board moving motor 18z of the axial-direction movement part 14z, and the top-board moving motor 18x of the longitudinal-direction movement part 14x, and includes a switching part 151, a step-up/step-down part 152, and a secondary battery 153.

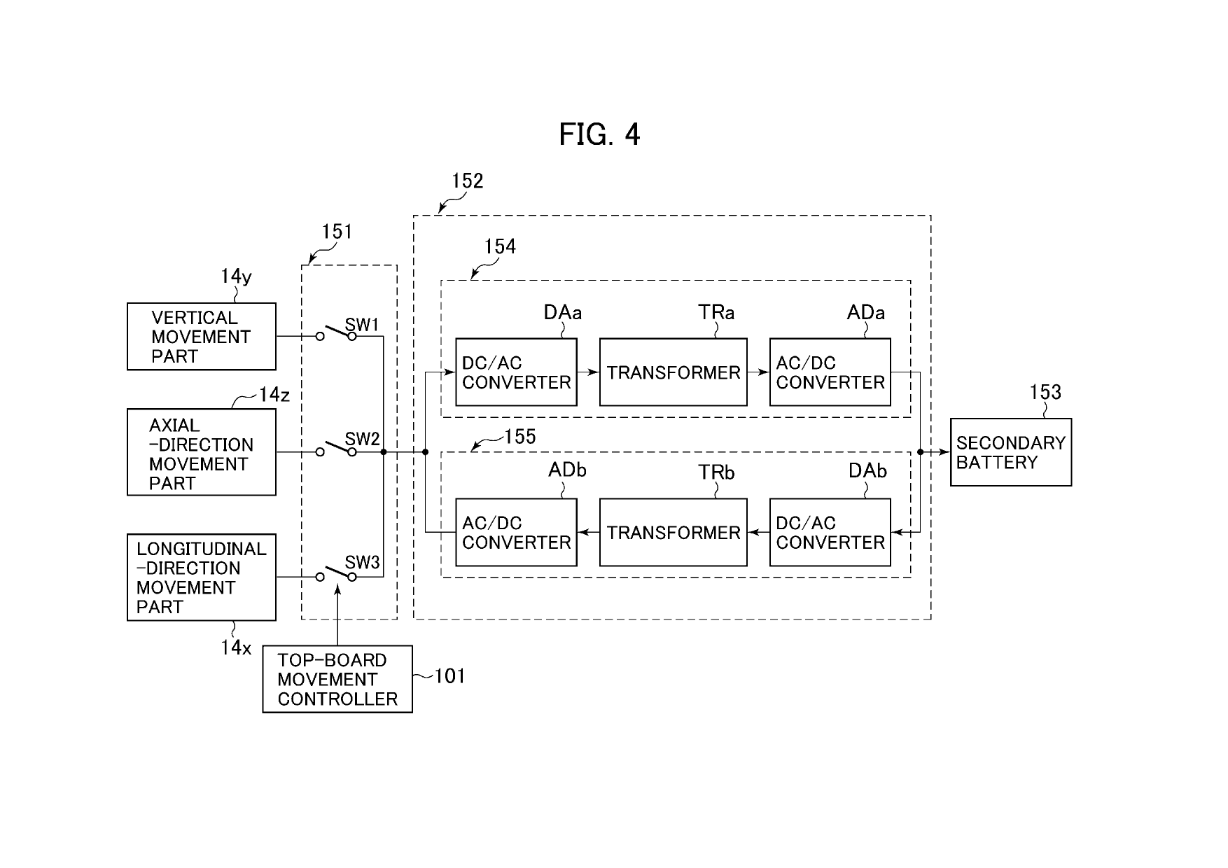

The switching part 151 is configured by, for example, high-voltage switching circuits SW1 through SW3 composed of three channels as shown in FIG. 4, and has a function to prevent leakage of the regenerative electric power charged in the secondary battery 153. In other words, based on control signals fed from the top-board movement controller 101, the switching part 151 detects top-board moving motors in a state of deceleration from among the top-board moving motors 18x through 18z, and switches the high-voltage switching circuit of the corresponding channel into a conductive (ON) state during the deceleration period. Moreover, if the regenerative electric power stored in the secondary battery 153 is used as standby power or retention energy required for operations of the top-board moving part 102 and/or the top-board movement controller 101, the switching part 151 switches the high-voltage switching circuit of the corresponding channel into a conductive state.

The step-up/step-down part 152 includes, for example, a step-down chopper 154 and a step-up chopper 155 as shown in FIG. 4. The step-down chopper 154 has a DC/AC converter DAa and an AC/DC converter ADa. The DC/AC converter DAa converts the DC voltage of the regenerative electric power fed from the top-board moving motors 18x through 18z via the DC/AC conversion parts 17x through 17z and the switching part 151 into AC voltage. The AC/DC converter ADa, together with a transformer TRa that steps down the converted AC voltage, converts the stepped-down AC voltage into DC voltage. On the other hand, the step-up chopper 155 has a DC/AC converter DAb and an AC/DC converter ADb. The DC/AC converter DAb converts the DC voltage of the regenerative electric power charged in the secondary battery 153 into AC voltage. The AC/DC converter ADb, together with a transformer TRb that steps up the converted AC voltage, converts the stepped-up AC voltage into DC voltage.

Then, the DC voltage output from the AC/DC converter ADb is fed via the switching part 151 to the vertical movement part 14y, the axial-direction movement part 14z, and the longitudinal-direction movement part 14x of the top-board moving part 102, is used as the main power source or as an auxiliary power source for driving the top-board moving motors 18x through 18z, and is also used as standby power for the top-board movement controller 101 and/or the top-board moving part 102.

The secondary battery 153 is configured by, for example, an electrical double-layer capacitor, and has sufficient capacity for the regenerative electric power that has been generated in each of the top-board moving motors 18x through 18z and undergone voltage conversion in the step-up/step-down part 152. Furthermore, because stepped-down regenerative electric power is stored in the secondary battery 153 by the step-up/step-down part 152, it becomes possible to use a secondary battery with a low withstand voltage. Moreover, by using an electrical double-layer capacitor as a secondary battery, the time required for charging and discharging regenerative electric power is shortened, thus allowing for efficient charging and discharging.

Returning to FIG. 1, the input part 11 includes an input device (such as a keyboard, a changeover switch, or a mouse, etc.) and a display panel, and forms an interactive interface by being used in combination with the display 5. Furthermore, the input part 11 performs the input of subject information, the setting of imaging conditions including the rotational velocity of the rotating gantry part 6, the setting of image-data generation conditions and image-data display conditions, and the input of various instruction signals including movement-initiation instruction signals for moving the top board 8 in a desired direction and movement-stopping instruction signals for stopping the top board 8 when it is moving.

Based on the abovementioned input information and setting information fed from the input part 11, the system controller 12 performs general control of each unit, including the irradiation-conditions controller 1, the projection-data generating part 3, the image-data generating part 4, the gantry rotating unit 9, and the top-board moving unit 10, and performs X-ray CT imaging of the subject 150.

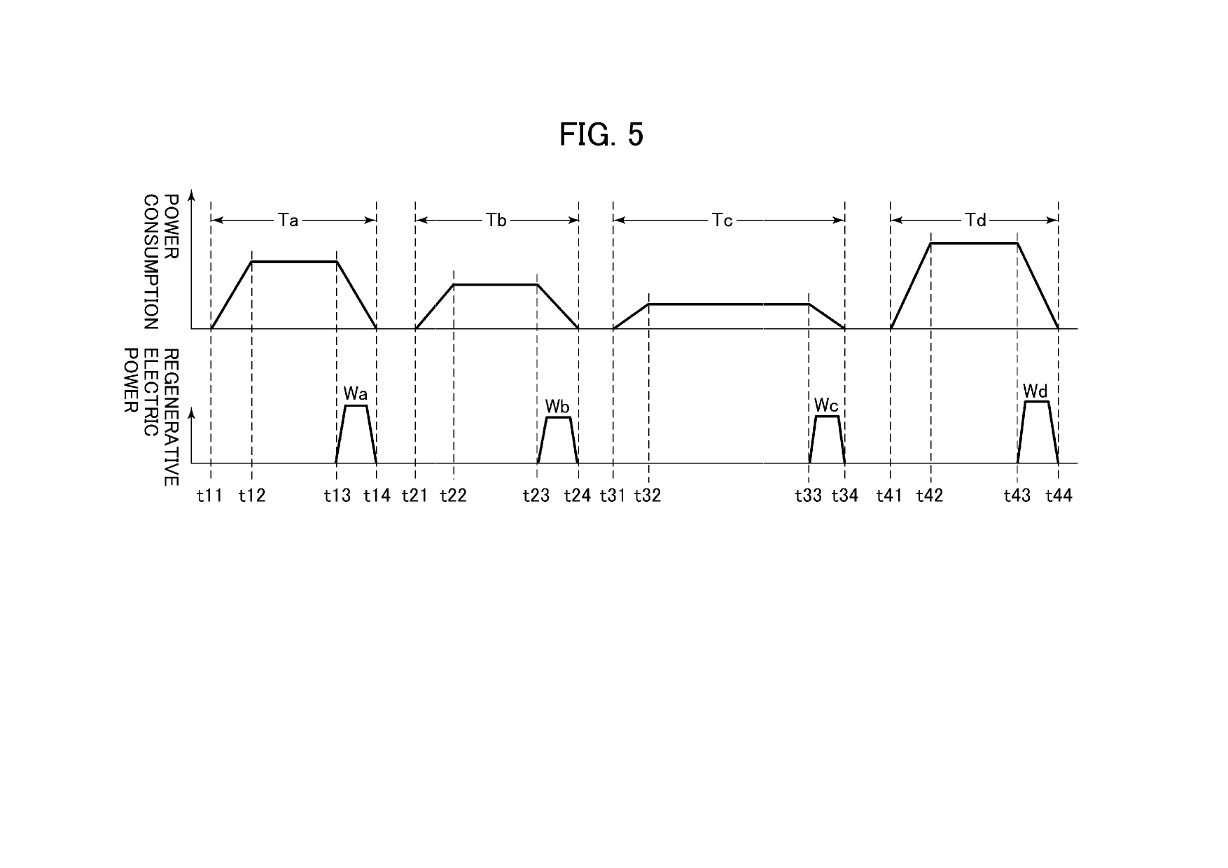

Next, the generation timing of regenerative electric power during X-ray CT imaging according to the present embodiment is described with reference to FIG. 5. The upper portion of FIG. 5 shows the size of the power consumption in the top-board moving motors 18x through 18z, and the lower portion of FIG. 5 shows the size and generation period of regenerative electric power generated during the deceleration of the top-board moving motors 18x through 18z.

In other words, in X-ray CT imaging according to the present embodiment, first, the subject 150 is placed and the top board 8 is moved in the upward direction (y-direction in FIG. 1) in the period Ta, and movement of the top board 8 in the body-axis direction (z-direction in FIG. 1) and the longitudinal direction (x-direction in FIG. 1) for the purpose of the initial settings of the subject 150 in relation to the imaging field is performed in the period Tb. Next, X-ray CT imaging of the subject 150 while the top board 8 is sequentially moved in the body-axis direction is performed in the period Tc, and movement of the top board 8 in the downward direction for the purpose of removing the subject 150 is performed in the period Td.

In this case, the power consumption in the top-board moving motors 18x through 18z is substantially proportional to the rotational velocity. The power consumption in the top-board moving motor 18y in the period [t11-t12] in which the top board 8 is accelerated upward, the power consumption of the top-board moving motor 18z and the top-board moving motor 18x in the period [t21-t22] in which the top board 8 is accelerated in the body-axis and longitudinal directions, the power consumption in the top-board moving motor 18z in the period [t31-t32] in which the top board 8 is accelerated in the body-axis direction, and the power consumption of the top-board moving motor 18y in the period [t41-t42] in which the top board 8 is accelerated downward gradually increase in accordance with the movement velocity of the top board 8.

Moreover, the power consumption of the top-board moving motor 18y in the period [t13-t14] in which the movement of the top board 8 upward is decelerated, the power consumption of the top-board moving motor 18z and the top-board moving motor 18x in the period [t23-t24] in which the movement of the top board 8 in the body-axis and longitudinal directions is decelerated, the power consumption of the top-board moving motor 18z in the period [t33-t34] in which the movement of the top board 8 in the body-axis direction is decelerated, and the power consumption of the top-board moving motor 18y in the period [t43-t44] in which the movement of the top board 8 downward is decelerated gradually decrease in accordance with the rotational velocity of the top board 8.

On the other hand, as shown in the lower portion of FIG. 5, regenerative electric power Wa is generated in the top-board moving motor 18y in the period [t13-t14] in which the movement of the top board 8 upward is decelerated, and regenerative electric power Wb is generated in the top-board moving motor 18z and the top-board moving motor 18x in the period [t23-t24] in which the movement of the top board 8 in the body-axis direction or longitudinal direction is decelerated. Similarly, regenerative electric power We is generated in the top-board moving motor 18z in the period [t33-t34] in which the movement of the top board 8 in the body-axis direction is decelerated. Moreover, regenerative electric power Wd is generated in the top-board moving motor 18y in the period [t43-t44] in which the movement of the top board 8 downward is decelerated. Then, the abovementioned regenerative electric power Wa through Wd is stored (charged) in the secondary battery 153 via the DC/AC conversion parts 17x through 17z, the switching part 151, and the step-up/step-down part 152 shown in FIG. 2.

Furthermore, if a shuttle helical scan, in which imaging is continuously performed while repeating the reciprocation of the top board 8 in the body-axis direction, the acceleration and deceleration of the top board 8 in the body-axis direction is repeated multiple times in the period Tc, and the regenerative electric power generated in the top-board moving motor 18z during the deceleration period is sequentially stored in the secondary battery 153.

Moreover, in the period Td, when the top board 8 is moved downward to release the subject 150, in addition to the kinetic energy of the top-board moving motor 18y, the decrease in potential energy is also converted into regenerative electric power, and as a result, a particularly large regenerative electric power is generated. Consequently, by preferentially storing regenerative electric power generated in the top-board moving motor 18y in the period Td, it is possible to efficiently perform charging and discharging of the secondary battery 153.

Then, the regenerative electric power stored in the secondary battery 153 is fed into input terminals of the DC/AC conversion parts 17x through 17z via the step-up/step-down part 152 and the switching part 151, and is used as driving power for the top-board moving motors 18x through 18z. In this case, the regenerative electric power stored in the secondary battery 153 may be fed into each of the top-board moving motors 18x through 18z, but it is also possible to, for example, selectively feed it to channels of the AC/DC conversion parts 16x through 16z in which the output voltage is equal to or less than a prescribed value. Moreover, the regenerative electric power stored in the secondary battery 153 may also be used as standby power or retention energy for the top-board movement controller 101 and/or the top-board moving part 102.

### Modification 1

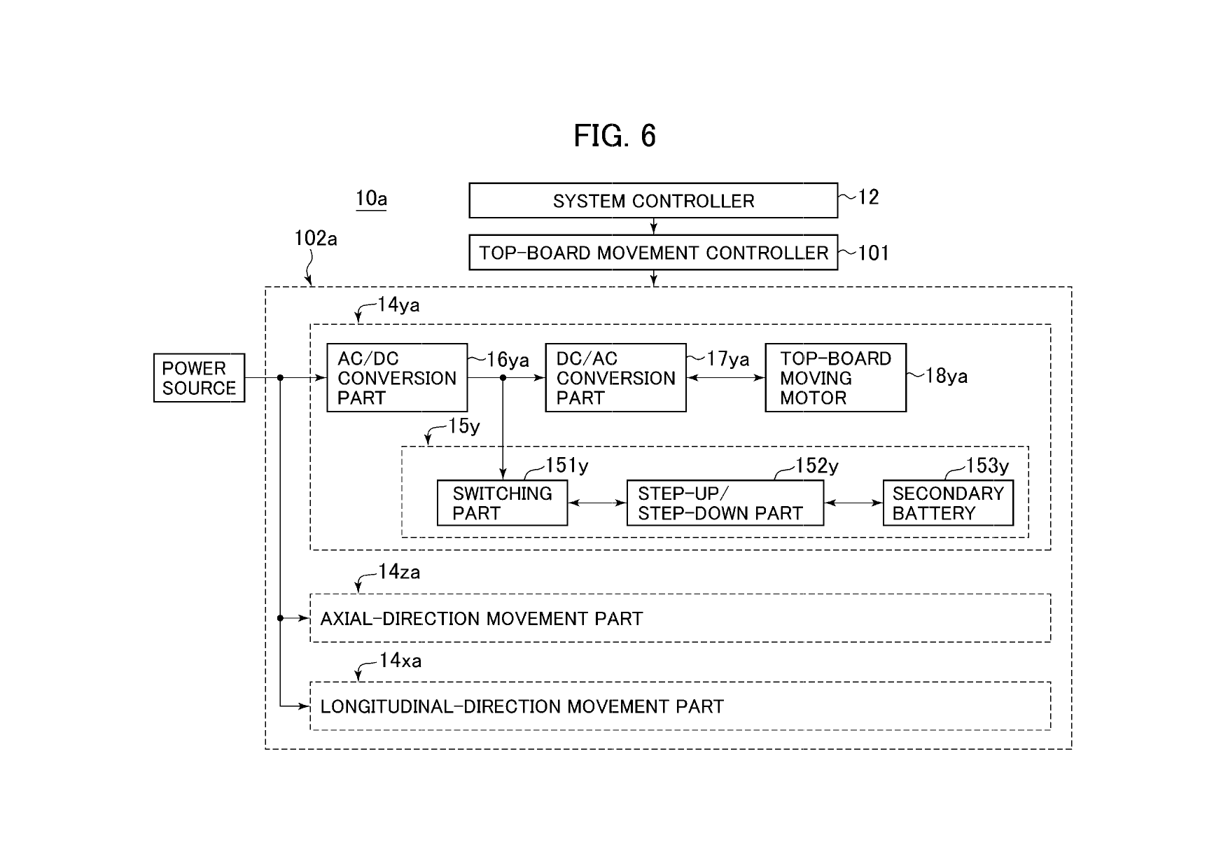

Next, a first modification of the present embodiment will be described with reference to FIG. 6. In FIG. 6, which shows the specific configuration of a top-board moving unit according to the present modification, units with identical configurations and functions as those of the top-board moving unit 10 shown in FIG. 2 have been assigned identical symbols, and detailed descriptions are omitted.

In the abovementioned embodiment, a case has been described in which the regenerative electric power generated from each of the top-board moving motors 18x through 18z is stored in a common charge-discharge part 15, but embodiments are not limited to this. For example, as shown in FIG. 6, charge-discharge parts 15x through 15z that are exclusive to the top-board moving motors 18x through 18z, respectively, may be included.

In other words, the top-board moving part 102a of the top-board moving unit 10a shown in FIG. 6 includes a vertical movement part 14ya, an axial-direction movement part 14za, and a longitudinal-direction movement part 14xa. The vertical movement part 14ya includes an AC/DC conversion part 16ya, a DC/AC conversion part 17ya, a top-board moving motor 18ya, and a charge-discharge part 15y. The axial-direction movement part 14za and the longitudinal-direction movement part 14xa include a similar AC/DC conversion part, DC/AC conversion part, top-board moving motor, and charge-discharge part (none shown in the diagram). By using such exclusive charge-discharge parts 15x through 15z, it becomes possible to use secondary batteries 153x through 153z with small capacity.

### Modification 2

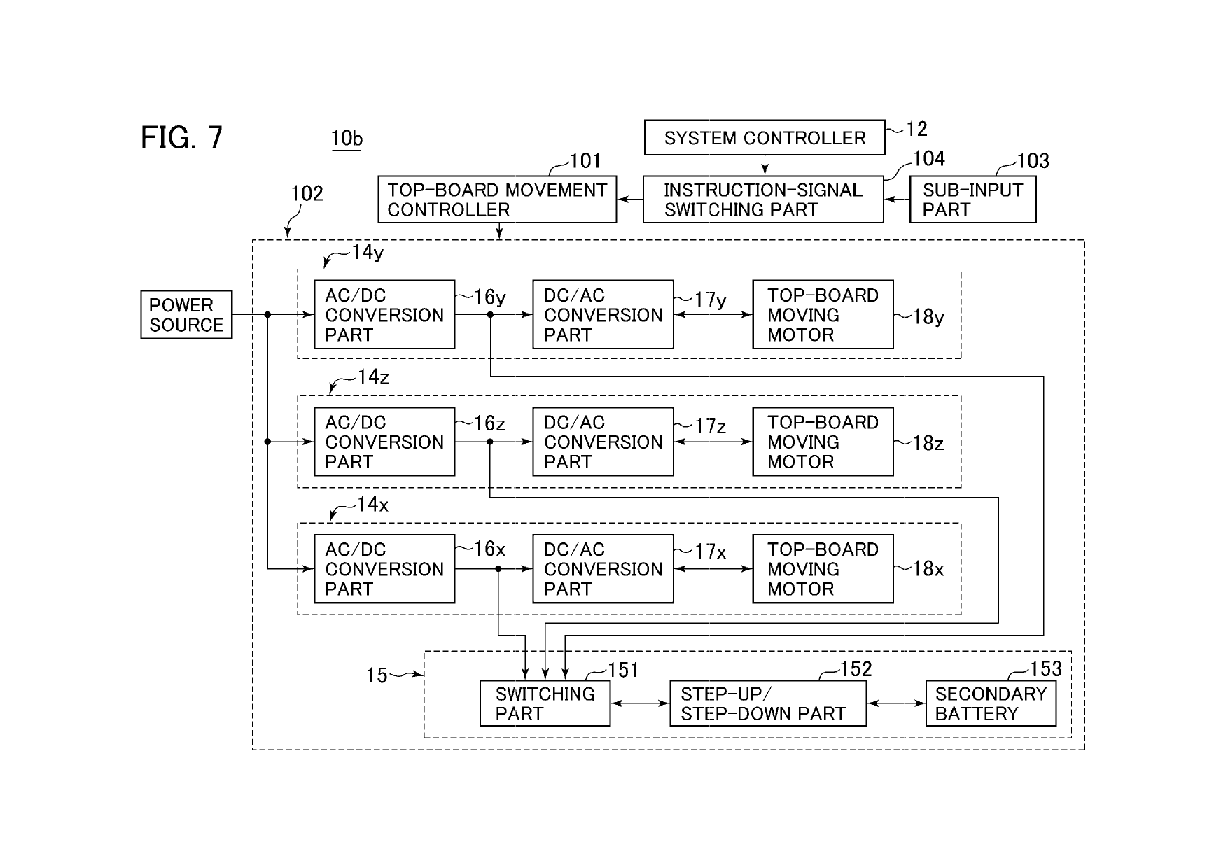

Next, a second modification of the present embodiment is described with reference to FIG. 7. In FIG. 7, which shows the specific configuration of a top-board moving unit according to the present modification, units with identical configurations and functions as those of the top-board moving unit 10 shown in FIG. 2 have been assigned identical symbols, and detailed descriptions are omitted.

In the above embodiment, if the regenerative electric power stored in the secondary battery 153 is used as standby power for operating the top-board movement controller 101 and/or the top-board moving part 102, it becomes possible to operate the top-board moving part 102 and/or the top-board movement controller 101 based on various instruction signals fed from the input part 11. In the present modification, the top-board moving unit further includes a sub-input part that allows for the input of the abovementioned instruction signals, and an instruction-signal switching part that is capable of switching between instruction signals fed from the input part 11 via the system controller 12 and instruction signals fed from the sub-input part.

In other words, the top-board moving unit 10b shown in FIG. 7 includes a sub-input part 103, an instruction-signal switching part 104, a top-board movement controller 101, and a top-board moving part 102. The top-board moving part 102 includes a vertical movement part 14y, an axial-direction movement part 14z, a longitudinal-direction movement part 14x, and a charge-discharge part 15. The sub-input part 103 performs the input, etc. of various instruction signals. The instruction-signal switching part 104 performs switching between instruction signals fed from the input part 11 via the system controller 12 and instruction signals fed from the sub-input part 103. The top-board movement controller 101 generates movement control signals based on movement-initiation instruction signals for initiating movement of the top-board 8 or movement-stopping instruction signals for stopping the movement, that are fed from the input part 11 or the sub-input part 103 via the instruction-signal switching part 104. The vertical movement part 14y moves the top board 8 on which the subject 150 is placed in the vertical direction. The axial-direction movement part 14z moves the top board 8 in the direction of the body axis of the subject 150. The longitudinal-direction movement part 14x moves the top board 8 in the longitudinal direction of the subject 150. The charge-discharge part 15 charges and discharges regenerative electric power generated in each of the vertical movement part 14y, the axial-direction movement part 14z, and the longitudinal-direction movement part 14x.

By including such a sub-input part 103 and instruction-signal switching part 104 in the top-board moving unit 10b, if the top board moving unit 10b is separated from the device body that includes the input part 11, or if an electrical problem occurs in the device body, etc., it is possible to perform operational checks of the top-board moving unit 10b using instruction signals fed from the sub-input part 103 and regenerative electric power fed from the secondary battery 153 of the charge-discharge part 15.

According to the embodiment described above and the modifications thereof, when moving a top board on which a subject is placed, it is possible to more effectively utilize regenerative electric power generated during the deceleration of the top-board moving motor by charging and discharging it. As a result, even if the power supply from the main power source to the top-board moving motor is not sufficient due to some problem, it becomes possible to operate the top-board moving motor using regenerative electric power stored inside the top-board moving unit, and in particular, if the abovementioned problem occurs during an examination, it is possible to remove the subject placed on the top board to a safe position.

Moreover, by using the regenerative electric power stored in the secondary battery of the top-board moving unit, this makes it easier to perform operational checks and inspections with only the top-board moving unit, and thus reduces the burden on service personnel and healthcare professionals responsible for such tasks. In this case, because the top-board moving unit includes: a sub-input part that allows for the input of various instruction signals; and an instruction-signal switching part that performs switching between instruction signals fed from the input part of a separately provided device body and instruction signals fed from the sub-input part, it is possible to perform the abovementioned operational checks and inspections more easily.

On the other hand, by using the regenerative electric power stored in the secondary battery of the top-board moving unit as driving power for the top-board moving motor or as standby power for operating the top-board movement controller, etc., it is possible to reduce the power fed from the main power source and thereby reduce power consumption.

Moreover, because it is possible to greatly reduce heat generation caused by regenerative electric power, it is possible to simplify the heat-releasing structures of the top-board moving unit, etc. Furthermore, because it becomes possible to raise the operating frequency of the top-board moving motor, it is possible to perform, for example, shuttle helical scans in which imaging is performed while repeating the reciprocation of the top board.

Furthermore, by switching the switching part provided in the charge-discharge part to a conductive state in periods in which regenerative electric power is generated or periods in which the power supply voltage fed from the power source becomes equal to or less than a prescribed value, it is possible to efficiently charge and discharge regenerative electric power in the secondary battery.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. For example, in the abovementioned embodiments, a medical image diagnosis apparatus that allows for the generation of X-ray CT image data has been described, but an embodiment may be a medical image diagnosis apparatus that generates X-ray image data, MRI image data, nuclear medical image data, or other image data.

Moreover, a case has been described in which the switching part provided in the charge-discharge part is switched to a conductive state in periods in which regenerative electric power is generated or periods in which the power supply voltage fed from the power source becomes equal to or less than a prescribed value, the abovementioned switching part is not always necessary. For example, by directly connecting the input terminal of the DC/AC conversion part with the step-up/step-down part, regenerative electric power for supplementing the power source voltage is automatically fed from the secondary battery via the step-up/step-down part.

Furthermore, in the abovementioned embodiment and the modifications thereof, a case has been described in which the top-board movement controller that generates movement control signals based on instruction signals from the system controller is included inside the top-board moving unit, but the top-board movement controller may be arranged outside the top-board moving unit. Moreover, the system controller may have the functions of the top-board movement controller.

On the other hand, in the abovementioned second modification, a top-board moving unit having a sub-input part that allows for the input of various instruction signals and an instruction-signal switching part that performs switching between instruction signals has been described, but instead of the sub-input part, an interface that allows for connections with a PC (personal computer) may be included. Through a connection with a PC, it becomes possible to perform more detailed operational checks and performance assessments.

1. A top-board moving unit comprising:
a top-board moving motor that moves, in a prescribed direction, a top board on which a subject is placed;
a drive-signal generating means that generates drive signals for causing said top-board moving motor to operate; and
a charge-discharge means that charges and discharges regenerative electric power generated in said top-board moving motor.

2. The top-board moving unit according to claim 1, wherein said charge-discharge means comprises:
a step-up/step-down means that steps down or steps up the voltage of said regenerative electric power; and
a secondary battery that stores stepped-down regenerative electric power.

3. The top-board moving unit according to claim 2, wherein said charge-discharge means further comprises a switching means, and said switching means enters a conductive state during the generative period of said regenerative electric power, thereby feeding the regenerative electric power generated in said top-board moving motor to said step-up/step-down means.

4. The top-board moving unit according to claim 1, wherein said drive-signal generating means generates said drive signals by using said regenerative electric power stored in said charge-discharge means as a main power source or an auxiliary power source.

5. The top-board moving unit according to claim 1, further comprising:
an input means that inputs an instruction signal; and
a top-board movement control means that, based on said instruction signal, controls the charging and discharging of said regenerative electric power for said charge-discharge means and the movement of said top board caused by said regenerative electric power.

6. The top-board moving unit according to claim 1, further comprising:
an interface that connects with a separately provided terminal device; and
a top-board movement control means that, based on an instruction signal fed from said terminal device, controls the charging and discharging of said regenerative electric power for said charge-discharge means and the movement of said top board caused by said regenerative electric power.

7. The top-board moving unit according to claim 1, including a plurality of top-board moving motors corresponding to each of a plurality of different movement directions, wherein regenerative electric power generated in these top-board moving motors is stored by a common charge-discharge means.

8. A medical image diagnosis apparatus that performs various types of imaging by moving, in a prescribed direction, a top board on which a subject is placed, and moves said top board using the top-board moving unit according to claim 1.

9. The medical image diagnosis apparatus according to claim 8, wherein:
said top-board moving motor reciprocates said top board in the body-axis direction of said subject; and
said various types of imaging are performed while repeating the reciprocation.
